(19) United States
(12) Patent Application Publication
(10) Pub. No.: US 2025/0251100 A1
(43) Pub. Date: Aug. 7, 2025

(54) FOUNTAIN LAMP WITH WATER ENTRY SENSING AND DISINFECTION DEVICE

(71) Applicant: Shenzhen Haike Plastic Electronics Co., Ltd., Shenzhen (CN)

(72) Inventors: Gangbin Wan, Sichuan Province (CN); Jianliang Xiong, Fuzhou City (CN)

(21) Appl. No.: 18/759,949

(22) Filed: Jun. 30, 2024

Related U.S. Application Data
(63) Continuation-in-part of application No. 18/434,323, filed on Feb. 6, 2024.

(51) Int. Cl. F21S 9/03; B05B 17/08; F04B 49/02; F04B 49/06; F21V 31/00; F21V 33/00; F21W 121/02; G01F 23/26

(52) U.S. Cl. CPC F21S 9/037; B05B 17/08; F04B 49/02; F04B 49/06; F21V 31/005; F21V 33/004; G01F 23/261; F21W 2121/02

(57) ABSTRACT

A fountain lamp with a water entry sensing and disinfection device, includes a housing, a lighting component, a pumping component, a water entry sensing device, and a control component. The housing is provided in an upper part with a closed floating chamber and a water outlet channel passing through the floating chamber. The water outlet channel is provided with water spray holes at an upper end. The lighting component is disposed within the floating chamber and configured for projecting light to form a column of light. The pumping component is connected to the housing and at least partially provided at a lower part of the floating chamber, the pumping component is in communication with the water outlet channel. The water entry sensing device is installed inside the housing. The control component is electrically connected to the water entry sensing device and the pumping component.

### CROSS-REFERENCE TO RELATED APPLICATIONS

This application is a Continuation-in-part Application of the U.S. application Ser. No. 18/434,323 filed on Feb. 6, 2024, and entitled “FOUNTAIN LAMP WITH A DISINFECTION DEVICE,” now pending.

### TECHNICAL FIELD

The present invention relates to the technical field of lighting devices, and in particular to a fountain lamp with a water entry sensing and disinfection device.

### BACKGROUND ART

As an ornamental landscape light, fountain lamps are widely used in gardens, parks, fountains, aquariums, courtyard ponds, swimming pools and ponds. Floating fountain lamps that can float on the surface of the water in swimming pools and ponds, and etc., are especially favored because of their ease of movement, easy maintenance and other advantages.

At present, the existing floating fountain lamps on the market usually includes a pump, a lighting lamp and a shell. The shell forms a floating chamber, so that the product floats on the water surface. The pump will pump water and launch the water column. The lighting lamp, on the other hand, projects light into the water column. However, during use, once the liquid surface in the swimming pool is too low, the pump of the product detaches from the liquid surface, which will cause the pump idling, thus not only wasting energy but also causing damage to the pump, shortening the product's service life and affecting the user experience.

Therefore, a fountain lamp with a water entry sensing and disinfection device is provided by the present invention, which can effectively solve the above problems. The fountain lamp has a simple structure and convenient use, and can detect a position of the liquid surface. When the liquid surface is lower than the pump, the pump can be automatically closed, thereby saving energy and prolonging the service life of the product.

### SUMMARY

In order to overcome the shortcomings of the prior art, a fountain lamp with a water entry sensing and disinfection device is provided by the present invention. The fountain lamp has a simple structure and convenient use, and can detect a position of a liquid surface. When the liquid surface is lower than a pump, the pump can be automatically closed, thereby saving energy and prolonging the service life of the product.

The technical solution adopted by the present invention to solve its technical problems is as follows.

A fountain lamp with a water entry sensing and disinfection device, includes a housing, a lighting component, a pumping component, a water entry sensing device, and a control component.

The housing is provided in an upper part with a closed floating chamber and a water outlet channel passing through the floating chamber. The water outlet channel is provided with water spray holes at an upper end.

The lighting component is disposed within the floating chamber and configured for projecting light to form a column of light.

The pumping component is connected to the housing and at least partially provided at a lower part of the floating chamber. The pumping component is in communication with the water outlet channel. The pumping component is used for pumping water through the water outlet channel to the water spray holes to form a column of water.

The water entry sensing device is installed inside the housing. A horizontal plane where a sensing end of the water entry sensing device is positioned is lower than a horizontal plane where a water pumping opening of the pumping component is positioned. The water entry sensing device is configured for detecting whether a liquid surface submerges the water pumping opening of the pumping component and outputting a control signal.

The control component is electrically connected to the water entry sensing device and the pumping component. The control component receives the control signal and controls the pumping component to be turned on or turned off.

As an improvement of the present invention, a lower part of the housing is equipped with a disinfection chamber and first through holes communicated with the disinfection chamber. The housing floats on the water surface under the action of the floating chamber. The disinfection chamber is configured for accommodating a disinfecting substance and immersing the disinfecting substance in water. The first through holes are configured for allowing water to pass through.

As an improvement of the present invention, the water entry sensing device is a capacitive water level sensor. The capacitive water level sensor is arranged inside the floating chamber and abuts against an inner wall of the floating chamber. The capacitive water level sensor is configured for detecting changes in water level through a sensing electrode and outputting the control signal.

As an improvement of the present invention, the pumping component is a brushless water pump.

As an improvement of the present invention, the lighting component includes a first lighting device and a second lighting device. The first lighting device is provided on a side of the floating chamber close to an upper surface of the housing. The first lighting device is configured for producing a column of light passing through a top of the housing, and the light column at least partially overlaps with the water column. The second lighting device is configured for generating light projected towards a side wall of the floating chamber, and the light at least partially penetrates out of the side wall of the floating chamber.

As an improvement of the present invention, the housing is further provided with an accommodation chamber and a second through hole in communication with the accommodation chamber. The accommodation chamber is disposed between the floating chamber and the disinfection chamber. The pumping component is disposed inside the accommodation chamber. The second through hole is configured for allowing water to pass through.

As an improvement of the present invention, the fountain lamp further includes a water outlet cover. The water spray holes are uniformly distributed in a circular shape along a surface of the water outlet cover. The water outlet cover is connected to the top of the housing and capped over the water outlet channel.

As an improvement of the present invention, the fountain lamp further includes a first sealing ring. The housing is provided with a first sealing groove. The first sealing ring is inserted in the first sealing groove. The water outlet cover is pressed against the first sealing groove.

As an improvement of the present invention, the housing includes a floating housing and a disinfection housing. The floating chamber is arranged inside the floating housing. The disinfection chamber is arranged inside the disinfection housing. The disinfection housing is connected to a lower part of the floating housing, and the accommodation chamber is formed between the disinfection housing and the floating housing.

As an improvement of the present invention, the disinfection housing includes an upper disinfection housing and a lower disinfection housing. The upper disinfection housing sleeves the lower disinfection housing. The lower disinfection housing is slidable up and down relative to the upper disinfection housing in order to change a volume of the disinfection chamber.

As an improvement of the present invention, the upper disinfection housing is provided with a first stop block in a lower part of an inner surface. The lower disinfection housing is provided with a second stop block in an upper part of an outer surface. The first stop block abuts against the second stop block.

As an improvement of the present invention, the upper disinfection housing is provided with a first slider on an inner surface thereof. The second stop block is provided with a sliding hole. The first slider is slidably disposed inside the sliding hole so that the lower disinfection housing is slidable relative to the upper disinfection housing.

As an improvement of the present invention, the fountain lamp further includes a rotating housing. The rotating housing is provided with a first opening. The upper disinfection housing is provided with a second opening. The rotating housing is rotatably sleeved in the upper disinfection housing and rotatable between an open position and a closed position rotating. When in the open position, the first opening aligns with the second opening. When in the closed position, the first opening is staggered from the second opening, and the rotating housing covers the second opening.

As an improvement of the present invention, the fountain lamp further includes an adjusting housing. The adjusting housing is provided with adjusting holes. The adjusting housing rotatably nests the lower disinfection housing and is rotatable between an open position and a closed position. When in the open position, the adjusting holes align with the first through holes. When in the closed position, the adjusting holes are misaligned with the first through holes, and the adjusting housing covers the first through holes.

As an improvement of the present invention, the lower disinfection housing is provided with third through holes at a bottom of the lower disinfection housing, and the third through holes are in communication with the disinfection chamber.

As an improvement of the present invention, the lower disinfection housing is further provided with a curved rotation groove at the bottom of the lower disinfection housing. The adjusting housing is provided with a second slider, and the second slider is slidably disposed in the rotation groove.

As an improvement of the present invention, a free end of the second slider is provided with a limiting block, and the limiting block abuts against an inner wall of the lower disinfection housing.

As an improvement of the present invention, the floating housing includes an upper floating housing and a lower floating housing. The upper floating housing is connected to and covers the lower floating housing. The floating chamber is formed between the upper floating housing and the lower floating housing.

As an improvement of the present invention, the fountain lamp further includes a second sealing ring. The upper floating housing is provided with a second sealing groove. The second sealing ring is arranged in the second sealing groove. The lower floating housing is inserted along the second sealing groove, and the lower floating housing abuts against the second sealing ring.

As an improvement of the present invention, the upper floating housing extends downwardly in a middle to form a connecting portion. The water outlet channel is provided in the connecting portion. The connecting portion is connected to a middle of the lower floating housing by a connecting member. A third sealing ring is provided between the connecting portion and the lower floating housing.

As an improvement of the present invention, the fountain lamp further includes a blocking member. The blocking member is detachably connected to a lower surface of the water outlet cover and inserted into the water outlet channel, so that a water outlet gap communicated with the water spray holes is formed between an inner wall of the water outlet channel and an outer wall of the blocking member.

As an improvement of the present invention, an inner wall of the accommodation chamber is provided with a snap-in member, and the snap-in member is engaged on an outer surface of the pumping component.

As an improvement of the present invention, the pumping component is provided with a filtering portion on a side near a water inlet, and the filtering portion is used for filtering impurities in the water.

As an improvement of the present invention, the fountain lamp further includes a battery. The control component and the battery are both provided in the floating chamber. The control component is electrically connected to the battery and the lighting component.

As an improvement of the present invention, the fountain lamp also includes a solar panel, the solar panel is set at a top of the floating chamber, and the solar panel is electrically connected to the control component.

As an improvement of the present invention, the fountain lamp also includes a drying block. The drying block is provided in the floating chamber and connected to the inner wall of the floating chamber.

The beneficial results of the present invention are as follows. When in use, the floating chamber is subjected to a buoyancy force of water, so that the product floats on the water, the lower part of the housing is immersed in the water, and the pumping component works to pump the water through the water outlet channel to the water spray holes, forming water columns. The lighting component works to produce light, the light is projected to the top of the product to form light columns, and the light columns and the water columns overlap to provide good lighting and decorative effect. Moreover, the light generated by the lighting component also passes through the side wall of the floating chamber and is projected on the water surface, providing additional lighting and decorative effects. Moreover, when the water surface height changes or a user takes or places the product, the water entry sensing device can detect whether the liquid surface submerges the water pumping opening of the pumping component. When the liquid surface is detected to submerge the water pumping opening of the pumping component, a first control signal is output, and the control component receives the first control signal and controls the pumping component to be turned on. When it is detected that the liquid surface has not submerged the water pumping opening of the pumping component, a second control signal is output. The control component receives the second control signal and controls the pumping component to be turned off, which can effectively prevent the pumping component from idling. On the one hand, energy can be saved, and on the other hand, motor damage can also be prevented and the service life of the product can be extended.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a schematic diagram of an overall structure of the present invention;

FIG. 2 is a schematic diagram of an overall structure of the present invention viewed from another angle;

FIG. 3 is a schematic diagram of an exploded structure of the present invention;

FIG. 4 is a schematic diagram of an exploded structure from another angle of the present invention;

FIG. 5 is a schematic diagram of a partially exploded structure of the present invention;

FIG. 6 is a schematic diagram of a partially exploded structure from another angle of the present invention;

FIG. 7 is a schematic diagram of an overall structure of the present invention with a rotating housing in a closed position and an adjusting housing in an open position;

FIG. 8 is a schematic diagram of an overall structure of the present invention with both the rotating housing and the adjusting housing in the closed position;

FIG. 9 is a schematic diagram of a sectional view structure of the present invention with the rotating housing and the adjusting housing both in the open position;

FIG. 10 is a schematic diagram of a sectional view structure of the present invention with both the rotating housing and the adjusting housing in the closed position;

FIG. 11 is an enlarged view at circle A of FIG. 9;

FIG. 12 is an enlarged view at circle B of FIG. 10;

FIG. 13 is a schematic diagram of a sectional view structure from another angle according to the present invention; and

FIG. 14 is a circuit diagram of a water entry sensing device according to the present invention.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the features. In the description of embodiments of the application, “a plurality of” means two or more, unless otherwise specifically defined.

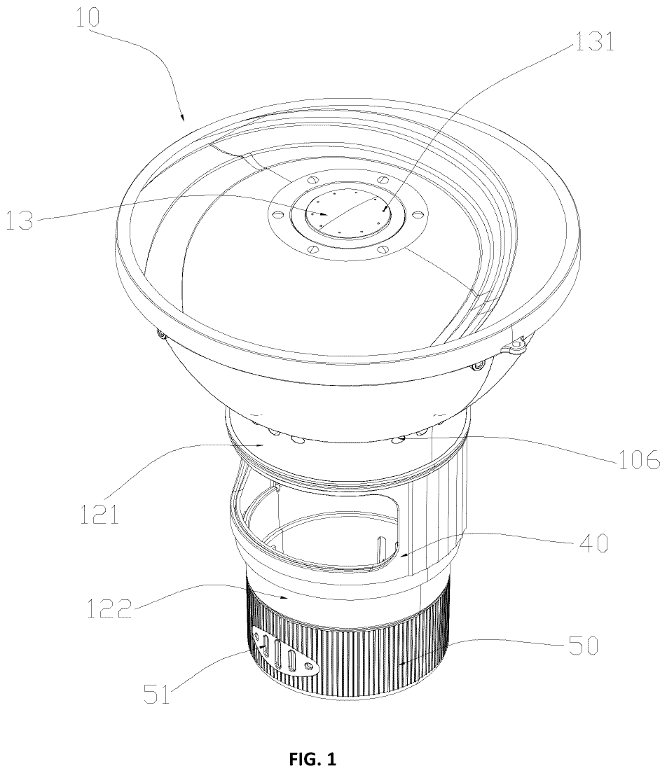

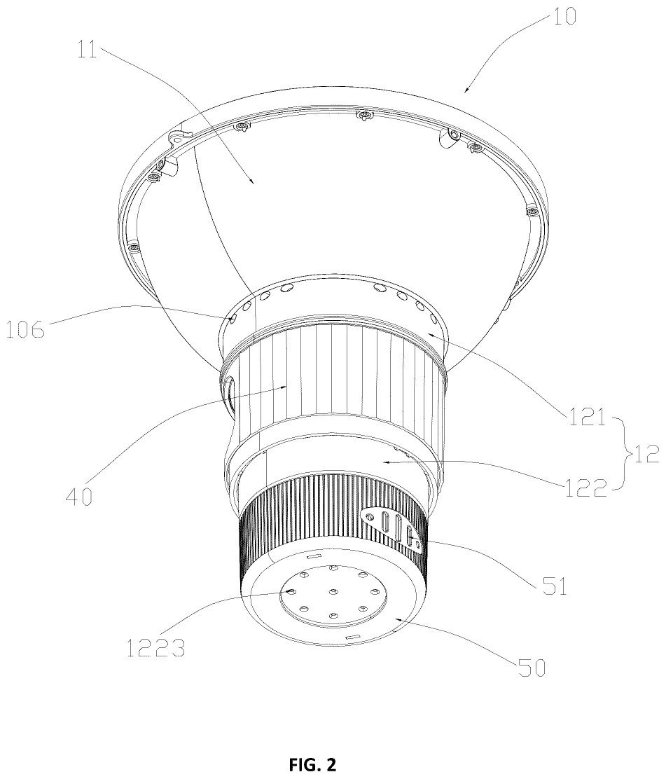

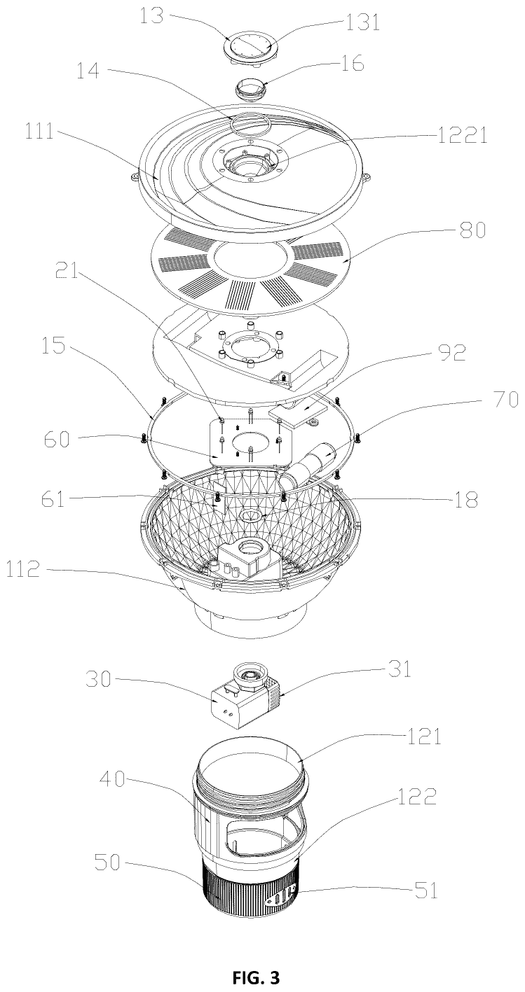

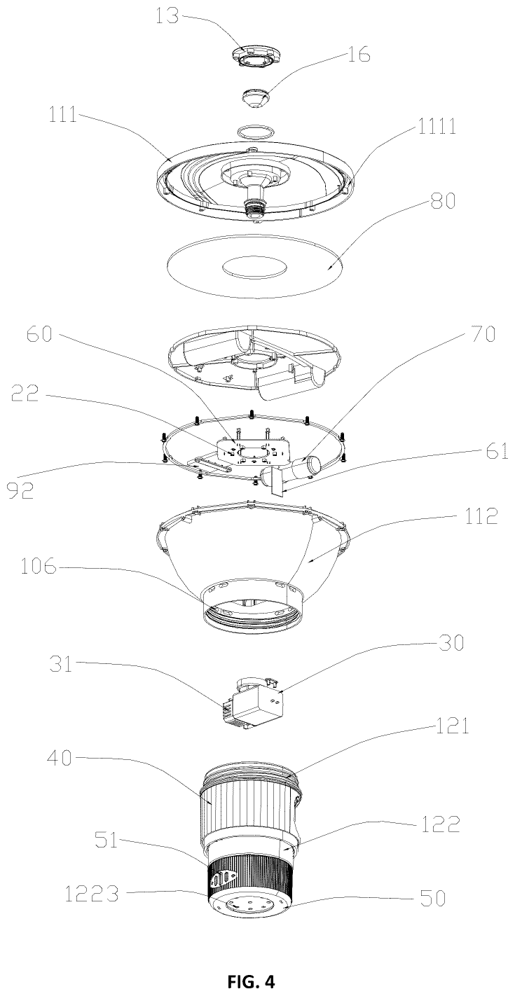

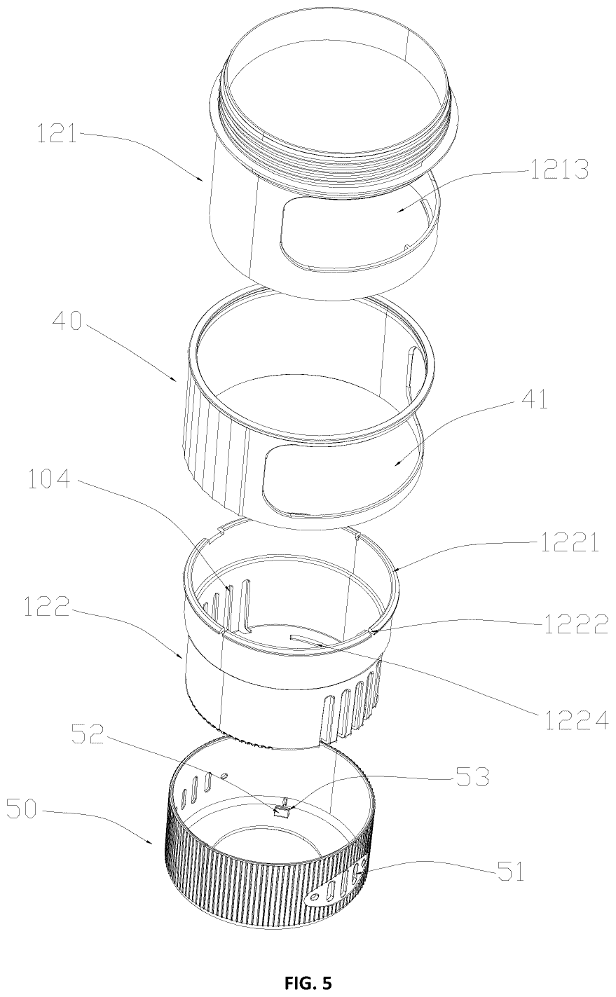

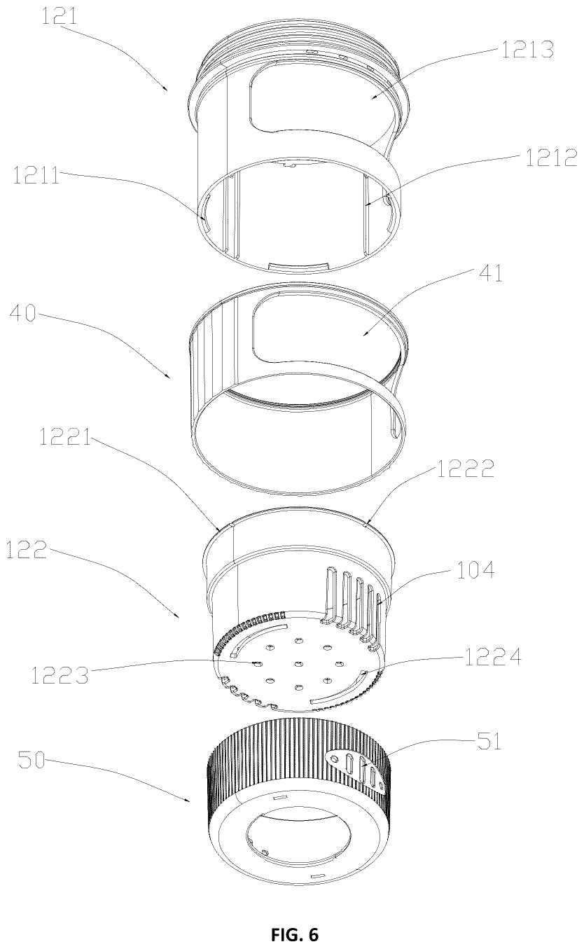

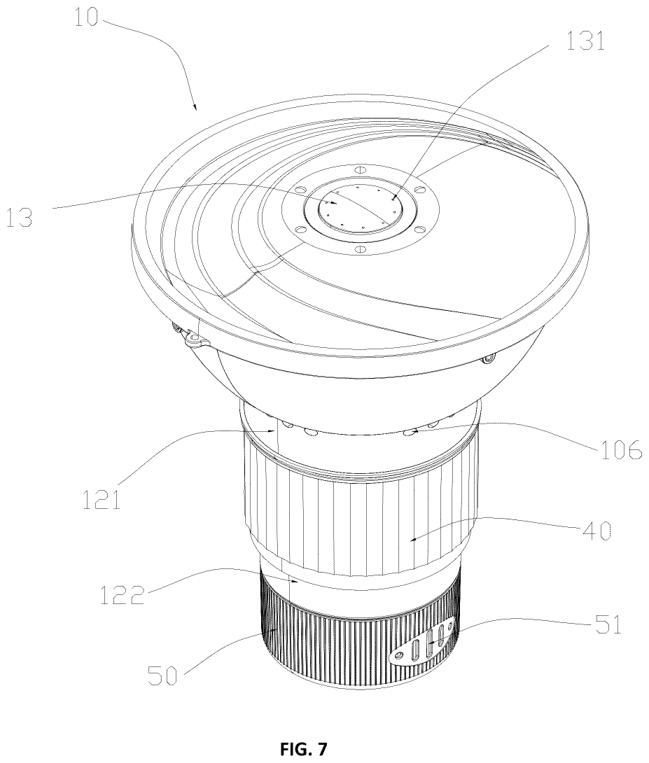

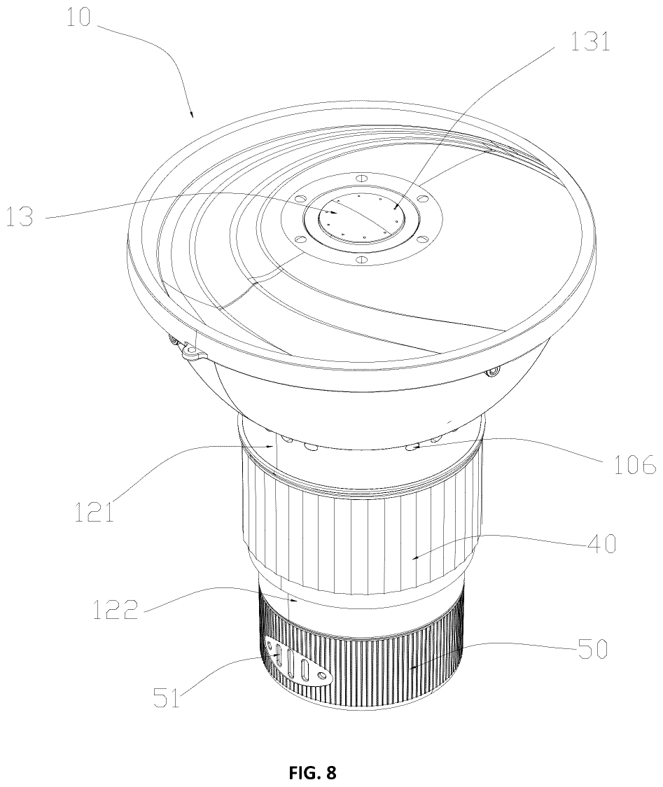

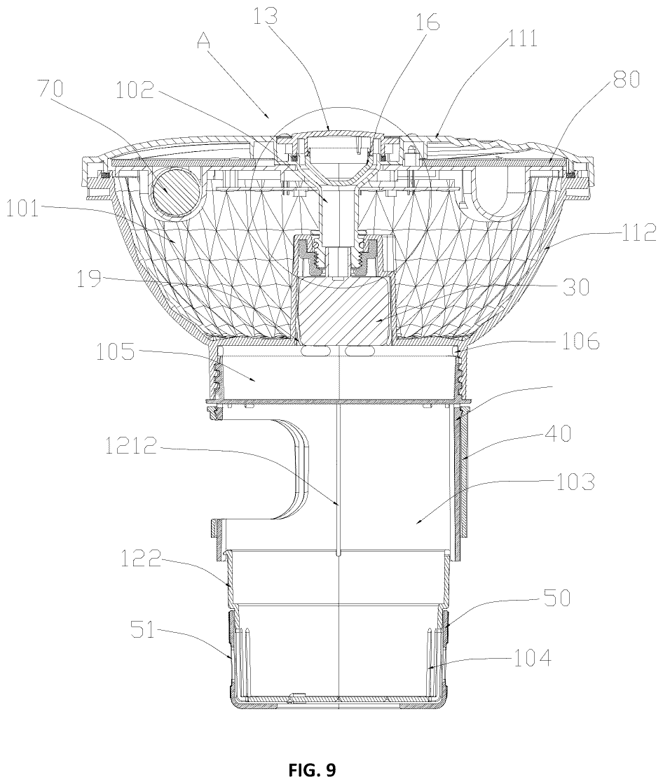

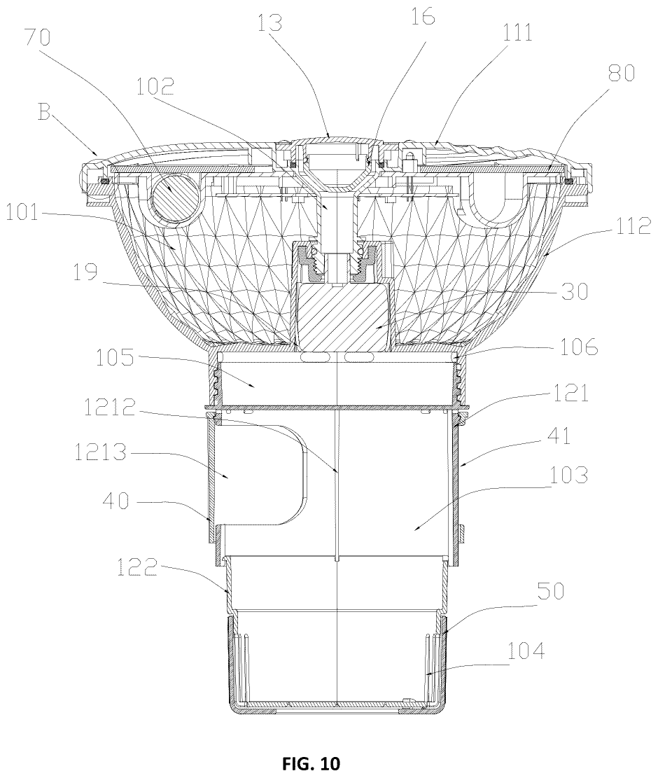

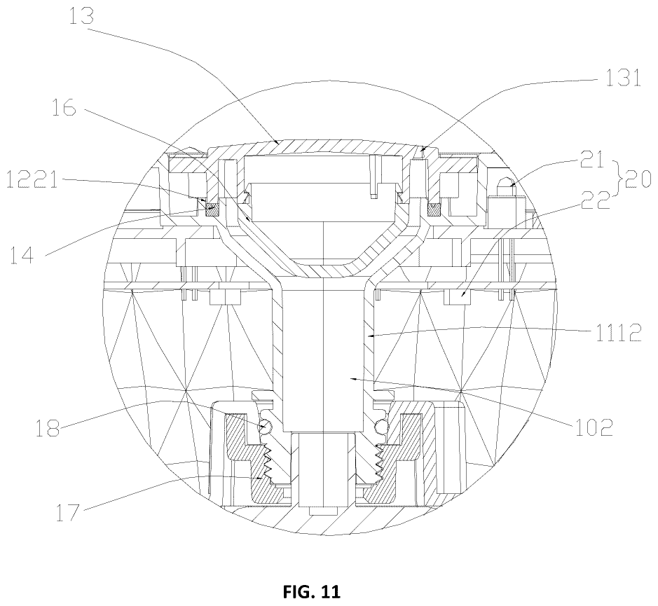

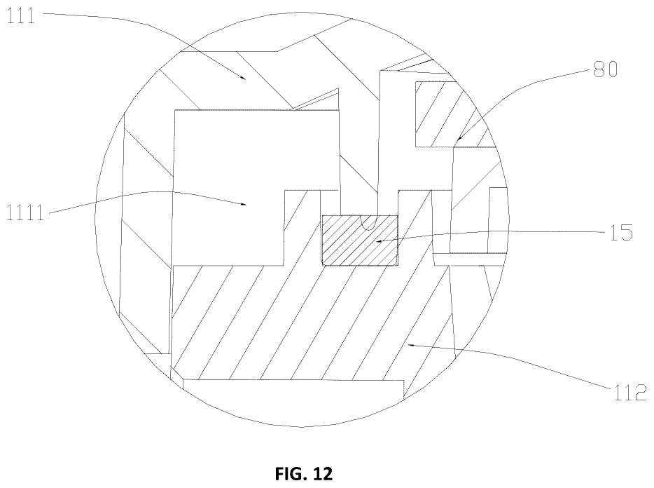

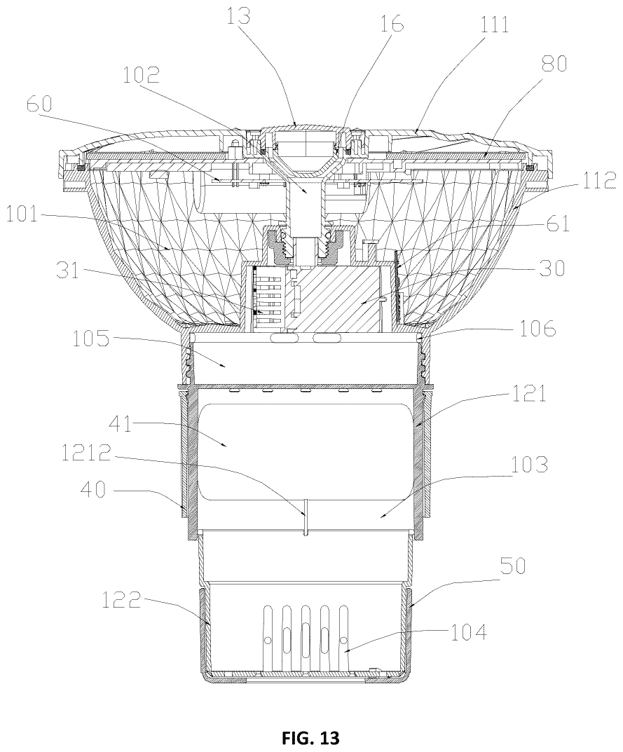

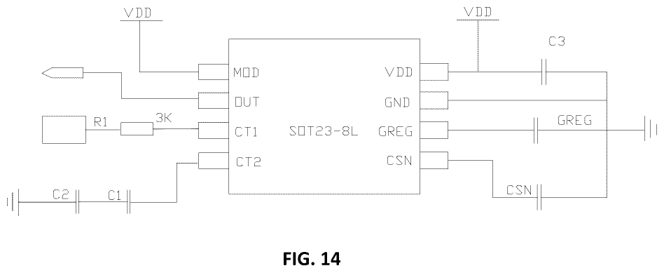

Referring to FIGS. 1-14, a fountain lamp with a water entry sensing and disinfection device, includes a housing 10, a lighting component 20, a pumping component 30, a water entry sensing device 61, and a control component 60.

The housing 10 is provided in an upper part with a closed floating chamber 101 and a water outlet channel 102 passing through the floating chamber 101. The water outlet channel 102 is provided with water spray holes 131 at an upper end.

The lighting component 20 is disposed within the floating chamber 101 and configured for projecting light to form a column of light.

The pumping component 30 is connected to the housing 10 and at least partially provided at a lower part of the floating chamber 101. The pumping component 30 is in communication with the water outlet channel 102. The pumping component 30 is used for pumping water through the water outlet channel 102 to the water spray holes 131 to form a column of water.

The water entry sensing device 61 is installed inside the housing 10. A horizontal plane where a sensing end of the water entry sensing device 61 is positioned is lower than a horizontal plane where a water pumping opening of the pumping component 30 is positioned. The water entry sensing device 61 is configured for detecting whether a liquid surface submerges the water pumping opening of the pumping component 30 and outputting a control signal.

The control component 60 is electrically connected to the water entry sensing device 61 and the pumping component 30. The control component 60 receives the control signal and controls the pumping component 30 to be turned on or turned off.

With the above structure, when in use, the floating chamber 101 is subjected to a buoyancy force of water, so that the product floats on the water, the lower part of the housing 10 is immersed in the water, and the pumping component 30 operates to pump the water through the water outlet channel 102 to the water spray holes 131 to form a sprayed water column. The lighting component 20 works to produce light and the light is projected to a top of the product to produce light columns, and the light columns overlap with the water columns to provide good lighting and decorative effects. Moreover, the light generated by the lighting component 20 also passes through a side wall of the floating chamber 101 and is projected onto the water surface, providing additional lighting and decorative effects. Moreover, when the water surface height changes or a user takes or places the product, the water entry sensing device 61 can detect whether the liquid surface submerges the water pumping opening of the pumping component 30. When the liquid surface is detected to submerge the water pumping opening of the pumping component 30, a first control signal is output, and the control component 60 receives the first control signal and controls the pumping component 30 to be turned on. When it is detected that the liquid surface has not submerged the water pumping opening of the pumping component 30, a second control signal is output. The control component 60 receives the second control signal and controls the pumping component 30 to be turned off, which can effectively prevent the pumping component 30 from idling. On the one hand, energy can be saved, and on the other hand, motor damage can also be prevented and the service life of the product can be extended.

In this embodiment, a lower part of the housing 10 is equipped with a disinfection chamber 103 and first through holes 104 communicated with the disinfection chamber 103. The housing 10 floats on the water surface under the action of the floating chamber 101, and the disinfection chamber 103 is configured for accommodating a disinfecting substance and immersing the disinfecting substance in water. The first through holes 104 are configured for allowing water to pass through. By setting up the above structure, the disinfection chamber 103 is provided with the disinfecting substance, and the disinfecting substance is immersed in the water, which can disinfect the water, and the first through holes 104 allow the water to pass through, so that the disinfecting substance can be diffused with the water flow. The disinfecting substance is a chloride such as calcium hypochlorite, which can effectively provide chlorine ions to sanitize the water at the swimming pool and the like.

In this embodiment, the water entry sensing device 61 is a capacitive water level sensor. The capacitive water level sensor is arranged inside the floating chamber 101 and abuts against an inner wall of the floating chamber 101. The capacitive water level sensor is configured for detecting changes in water level through a sensing electrode and outputting the control signal. By setting up the above structure, the capacitive water level sensor can detect a water level height outside the housing 10 across the inner wall of the floating chamber 101, and then output the control signal. The capacitive water level sensor can detect the water level without being immersed in the water, effectively preventing the pumping component 30 from idling, and extending the service life of the product. Moreover, the capacitive water level sensor does not need to be immersed in the water, which can prevent impurities, dirt, and sediment in the water from affecting the water level detection and improve the detection accuracy. Moreover, the capacitive water level sensor has high stability and strong reliability, and the capacitive type is easier to achieve integration and intelligent water level detection function. The capacitive water level sensor is based on the principle of dual channel comparison. One channel detects the environmental capacitance in the current anhydrous state, while the other channel detects the changes in the liquid inside a container through the sensing electrode. By comparing the difference in capacitance between the two channels with a preset threshold value inside a chip, a change of the liquid level inside a container wall or a change of the presence or absence of liquid can be determined, and then the water level can be determined.

In this embodiment, the pumping component 30 is a brushless water pump. By setting up the above structure, the brushless water pump has high control accuracy and fast response speed, and can respond promptly after the control component 60 issues a control command. Moreover, the brushless water pump has low energy consumption, long service life, low noise, and stable operation.

In this embodiment, the lighting component 20 includes a first lighting device 21 and a second lighting device 22. The first lighting device 21 is provided on a side of the floating chamber 101 near an upper surface of the housing 10. The first lighting device 21 works to produce a column of light passing through a top of the housing 10, and the column of light is at least partially overlapped with the column of water. The light generated by the operation of the second lighting device 22 is projected towards the side wall of the floating chamber 101 and at least partially penetrates out of the side wall of the floating chamber 101. By setting the above structure, the first lighting device 21 projects light towards the top of the product to form an upward light column, which is overlapped with the water column to illuminate the water column, so that the water column can flash with the light and have brilliant colors, and the lighting effect is better. The second lighting device 22 can project light towards the side wall of the floating chamber 101, and through the transparent side wall of the floating chamber 101, the light can be projected on the water surface, and the light can be reflected by the water surface to form a more beautiful lighting effect.

In this embodiment, the housing 10 is further provided with an accommodation chamber 105 and a second through hole 106 in communication with the accommodation chamber 105. The accommodation chamber 105 is provided between the floating chamber 101 and the disinfection chamber 103. The pumping component 30 is provided in the accommodation chamber 105, and the second through hole 106 is configured for allowing water to pass through. Through the above structure, the accommodation chamber 105 can receive the pumping component 30 and separate the pumping component 30 from the disinfecting substance in the disinfection chamber 103, preventing the pumping component 30 from pumping the disinfecting substance, and the two are separately set to slow down the speed of release of the disinfecting substance, prolonging the release time, and effectively disinfecting the inside of the swimming pool and other places. At the same time, the second through hole 106 allows water to pass through, thereby enabling the pumping component 30 to always be below the liquid surface, ensuring that the pumping component 30 can pump water to form a water column, ensuring the use of the product, and also preventing damage caused by the pumping component 30 being separated from the liquid surface, thereby prolonging the service life of the product.

In this embodiment, the fountain lamp further includes a water outlet cover 13. The water spray holes 131 are uniformly distributed in a ring shape along a surface of the water outlet cover 13. The water outlet cover 13 is connected to the top of the housing 10 and covers the water outlet channel 102. Through the above structure, the water spray holes 131 uniformly distributed along the ring shape can form a plurality of water columns to enhance the use effect of the product, while the separate setting of the water outlet cover 13 makes the water outlet cover 13 to be conveniently replaced when the water spray holes 131 are blocked or damaged, prolonging the service life of the product and reducing the property loss of the user.

In this embodiment, the fountain lamp further includes a first sealing ring 14. The housing 10 is provided with a first sealing groove 1221, the first sealing ring 14 is inserted in the first sealing groove 1221, and the water outlet cover 13 is engaged with the first sealing groove 1221. Through the structure described above, the first sealing ring 14 is inserted in the first sealing groove 1221, which can separate the water spray holes 131 and the water outlet channel 102 from the floating chamber 101, thereby improving the airtightness of the product, preventing water from entering the floating chamber 101, protecting the lighting component 20 and other electrical components set in the floating chamber 101, improving the service life of the product, and ensuring the safety of the use of the product.

In this embodiment, the housing 10 includes a floating housing 11 and a disinfection housing 12. The floating chamber 101 is set in the floating housing 11. The disinfection chamber 103 is set in the disinfection housing 12. The disinfection housing 12 is connected to a lower part of the floating housing 11. The accommodation chamber 105 is formed between the disinfection housing 12 and the floating housing 11. Through the configuration of the above structure, the floating housing 11 and the disinfection housing 12 are separate, and they can be produced separately to improve production efficiency. When in use, the floating housing 11 and the disinfection housing 12 are connected by a threaded structure, and the accommodation chamber 105 is formed between the disinfection housing 12 and the floating housing 11. The fountain lamp is simple in structure and easy to assemble. At the same time, when it is partially damaged, only parts of the product need to be replaced, thus reducing the user's property loss.

In this embodiment, the disinfection housing 12 includes an upper disinfection housing 121 and a lower disinfection housing 122. The upper disinfection housing 121 is sleeved in the lower disinfection housing 122, and the lower disinfection housing 122 is capable of sliding up and down relative to the upper disinfection housing 121 to change a volume of the disinfection chamber 103. Through the above structure, the upper disinfection housing 121 and the lower disinfection housing 122 are nested and connected to each other and can slide relative to each other, so that the size of the disinfection chamber 103 between the two can be changed to accommodate different amounts of disinfecting substances, to adapt to diversified user needs, and to reduce the volume of the product when transporting, so as to facilitate transportation and storage by the user.

In this embodiment, the upper disinfection housing 121 is provided with a first stop block 1211 in a lower part of an inner surface. The lower disinfection housing 122 is provided with a second stop block 1221 on an upper part of an outer surface. The first stop block 1211 is coupled with the second stop block 1221. Through the configuration of the above structure, in the process of use, when the lower disinfection housing 122 slides away from the upper disinfection housing 121 to an extreme position (i.e., a limiting position), the second stop block 1221 is coupled with the first stop block 1211, preventing the upper disinfection housing 121 and the lower disinfection housing 122 from detaching, and improving the stability of the product.

In this embodiment, the upper disinfection housing 121 is provided with a first slider 1212 on the inner surface. The second stop block 1221 is provided with a sliding hole 1222. The first slider 1212 is slidably disposed inside the sliding hole 1222, so that the lower disinfection housing 122 is capable of sliding relative to the upper disinfection housing 121. Through the above structure, when in use, the sliding hole 1222 cooperates with the first slider 1212 to enable the upper disinfection housing 121 and the lower disinfection housing 122 to slide relative to each other in an axial direction, restricting the relative movement of the two in a circumferential direction.

In this embodiment, the fountain lamp further includes a rotating housing 40. The rotating housing 40 is provided with a first opening 41, and the upper disinfection housing 121 is provided with a second opening 1213. The rotating housing 40 is rotatably coupled to the upper disinfection housing 121 and rotatable between an open position and a closed position. When in the open position, the first opening 41 corresponds to (aligns with) the second opening 1213. When in the closed position, the first opening 41 is staggered from the second opening 1213, and the rotating housing 40 is capped over the second opening 1213. Through the above structure, the rotating housing 40 can be rotated to adjust the relative positions of the first opening 41 and the second opening 1213 when in use. When the first opening 41 corresponds to the second opening 1213, they are in the open position, and the user's hand can pass through the first opening 41 and the second opening 1213 to put the disinfecting substance into the disinfection chamber 103 or take it out of the disinfection chamber 103. In the closed position, the first opening 41 and the second opening 1213 are staggered, the rotating housing 40 is capped over the second opening 1213, the disinfecting substance can be effectively prevented from leaving the disinfection chamber 103 through the first opening 41 and the second opening 1213. Thus, the stability of the product is ensured.

In this embodiment, the fountain lamp further includes an adjusting housing 50. The adjusting housing 50 is provided with adjusting holes 51. The adjusting housing 50 is rotatably coupled to the lower disinfection housing 122 and rotatable between an open position and a closed position. In the open position, the adjusting holes 51 align with the first through holes 104. In the closed position, the adjusting holes 51 are misaligned with the first through holes 104, and the adjusting housing 50 is capped over the first through holes 104. By setting the above structure, the adjusting housing 50 can be rotated to adjust the relative position of the adjusting holes 51 to the first through holes 104 when in use. In the open position, the adjusting holes 51 correspond to the first through holes 104, more water passes through the adjusting holes 51 and the first through holes 104, and the interaction rate of the water inside and outside of the disinfection chamber 103 can be effectively increased, thereby accelerating the escape rate of the disinfecting substance and improving the disinfection effect of the product. While in the closed position, the adjusting holes 51 and the first through holes 104 are staggered, and less water passes through the adjusting holes 51 and the first through holes 104, at which time the interaction rate of the water inside and outside the disinfection chamber 103 can be reduced, prolonging the time for the disinfecting substances to escape, and improving the duration of the disinfection of the product.

In this embodiment, third through holes 1223 are provided at a bottom of the lower disinfection housing 122, and the third through holes 1223 are in communication with the disinfection chamber 103. Through the above structure, the third through holes 1223 can still allow water to enter and exit the disinfection chamber 103 when the adjusting holes 51 and the first through holes 104 are staggered, so as to realize the interaction of the water inside and outside of the disinfection chamber 103, and thus realizing the escape of disinfecting substances, and guaranteeing the basic disinfection effect of the product.

In this embodiment, the bottom of the lower disinfection housing 122 is also provided with a curved rotation groove 1224. The adjusting housing 50 is provided with a second slider 52, and the second slider 52 is slidably engaged in the rotation groove 1224. With the structure described above, when in use, the second slider 52 is located in the rotation groove 1224, which can limit the relative rotation of the adjusting housing 50 and the lower disinfection housing 122 along a circumference, effectively improving the stability of the product.

In the present embodiment, a limiting block 53 is provided at a free end of the second slider 52, and the limiting block 53 abuts against an inner wall of the lower disinfection housing 122. Through the above structure, the limiting block 53 abuts against the inner wall of the lower disinfection housing 122, which can effectively prevent the lower disinfection housing 122 and the adjusting housing 50 from relatively detaching from each other, effectively enhancing the stability of the product.

In this embodiment, the floating housing 11 includes an upper floating housing 111 and a lower floating housing 112. The upper floating housing 111 is connected to and covers the lower floating housing 112. The floating chamber 101 is formed between the upper floating housing 111 and the lower floating housing 112. Through the setting of the above structure, the separate setting of the upper floating housing 111 and the lower floating housing 112 may facilitate production and improve the production efficiency of the product, and at the same time, it is also convenient to install the lighting component 20 and other electrical components in the floating chamber 101 during assembly, further facilitating production and improving production efficiency.

In this embodiment, the fountain lamp further includes a second sealing ring 15. The upper floating housing 111 is provided with a second sealing groove 1111. The second sealing ring 15 is provided in the second sealing groove 1111. The lower floating housing 112 is inserted along the second sealing groove 1111 and is pressed against the second sealing ring 15. Through the above structure, the second sealing ring is inserted into the second sealing groove 1111, and the lower floating housing 112 is pressed against the second sealing ring 15, which can effectively limit the second sealing ring 15, thereby enhancing the airtightness of the product, preventing water from entering the floating chamber 101, protecting the lighting component 20 and other electrical components set inside the floating chamber 101, enhancing the service life of the product, and safeguarding the safety of the use of the product.

In this embodiment, a middle part of the upper floating housing 111 extends downward to form a connecting portion 1112. The water outlet channel 102 is provided in the connecting portion 1112. The connecting portion 1112 is connected to a middle of the lower floating housing 112 through a connecting member 17. A third sealing ring 18 is provided between the connecting portion 1112 and the lower floating housing 112. Through the arrangement of the above structure, the third sealing ring 18 is provided between the connecting portion 1112 and the lower floating housing 112, which can further enhance the airtightness of the product and safeguard the use of the product.

In this embodiment, the fountain lamp further includes a blocking member 16. The blocking member 16 is detachably connected to a lower surface of the water outlet cover 13 and inserted into the water outlet channel 102, so that a water outlet gap communicated with the water spray holes 131 is formed between an inner wall of the water outlet channel 102 and an outer wall of the blocking member 16. Through the above structure, the blocking member 16 can block part of the water outlet channel 102 and form the water outlet gap between the inner wall of the water outlet channel 102, increase the water pressure of the water flow through the water outlet gap, and thus make the water pressure at the water spray holes 131 greater, so that the water column sprayed from the water spray holes 131 can spray higher and improve the use effect of the product.

In this embodiment, an inner wall of the accommodation chamber 105 is provided with a snap-in member 19, and the snap-in member 19 is coupled with an outer surface of the pumping component 30. Through the above structure, when in use, the pumping component 30 is inserted toward the accommodation chamber 105 until the installation position. The snap-in member 19 is coupled to the outer surface of the pumping component 30. This engagement can effectively fix the pumping component 30, facilitate product assembly, and improve the production efficiency of the product.

In this embodiment, the pumping component 30 is provided with a filtering portion 31 on one side near a water inlet, and the filtering portion 31 is used to filter impurities in the water. Through the above structure, the filtering portion 31 can effectively filter impurities, prevent excessive impurities from entering the water inlet of the pumping component 30, ensure the safety of the pumping component 30, and thus safeguard the safety of the use of the product.

In this embodiment, the fountain lamp further includes a battery 70. The control component 60 and the battery 70 are both provided in the floating chamber 101. The control component 60 is electrically connected to the battery 70 and the lighting component 20. Through the setting of the above structure, the battery 70 can provide electrical energy, improve the endurance of the product, and make the product can be detached from the utility power for use, thereby facilitating the carrying by the user, and increasing application scenario of the product. The control component 60 can control the lighting component to produce different lighting effects, and also allow the user to realize human-computer interaction through a button or a remote controller to improve the user's experience.

In this embodiment, the fountain lamp also includes a solar panel 80, the solar panel 80 is set at a top of the floating chamber 101, and the solar panel 80 is electrically connected to the control component 60. Through the above structure, the solar panel 80, when in use, can convert solar energy into electrical energy, and through the control device converts the voltage to store the electrical energy to the battery 70, which can effectively enhance the endurance of the product, and can save energy.

In this embodiment, the fountain lamp also includes a drying block 92. The drying block 92 is provided in the floating chamber 101 and connected to the inner wall of the floating chamber 101. Through the above structure, the drying block 92 can adsorb and remove the moisture inside the floating chamber 101, further safeguarding the dryness inside the floating chamber 101, preventing the electrical components inside the floating chamber 101 from being damp, improving the service life of the product, and safeguarding the user's safety of use.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

1. A fountain lamp, comprising:
a housing, wherein the housing is provided with a closed floating chamber in an upper part and a water outlet channel passing through the floating chamber, the water outlet channel is provided with water spray holes arranged in a circle at an upper end, and the floating chamber is transparent;
a solar panel arranged inside the floating chamber, proximal to a top of the floating chamber, and having a central through hole defined therein;
a lighting component, wherein the lighting component is arranged inside the floating chamber and configured for projecting light to form a column of light, the lighting component comprises a plurality of first lighting devices arranged in a circle and passing through the central through hole of the solar panel to face the top of the floating chamber;
a pumping component, wherein the pumping component is connected to the housing and at least partially provided at a lower part of the floating chamber, the pumping component is in communication with the water outlet channel, and the pumping component is used for pumping water through the water outlet channel to the water spray holes to form a column of water;
a water entry sensing device, wherein the water entry sensing device is installed inside the housing, a horizontal plane where a sensing end of the water entry sensing device is positioned is lower than a horizontal plane where a water pumping opening of the pumping component is positioned, and the water entry sensing device is configured for detecting whether a liquid surface submerges the water pumping opening of the pumping component and outputting a control signal; and
a control component, wherein the control component is electrically connected to the water entry sensing device and the pumping component, and the control component is configured for receiving the control signal and controlling the pumping component to be turned on or turned off.

2. The fountain lamp according to claim 1, wherein a lower part of the housing is equipped with a disinfection chamber and first through holes communicated with the disinfection chamber, the housing floats on the water surface under the action of the floating chamber, the disinfection chamber is configured for accommodating a disinfecting substance and immersing the disinfecting substance in water, and the first through holes are configured for allowing water to pass through.

3. The fountain lamp according to claim 1, wherein the water entry sensing device is a capacitive water level sensor, the capacitive water level sensor is arranged inside the floating chamber and abuts against an inner wall of the floating chamber, and the capacitive water level sensor is configured for detecting changes in water level through a sensing electrode and outputting the control signal.

4. The fountain lamp according to claim 1, wherein the lighting component further comprises a plurality of second lighting devices, the first lighting device is provided on a side of the floating chamber proximal to an upper surface of the housing, each of the first lighting devices is configured for producing a column of light passing through a top of the housing, and the light column at least partially overlaps with the water column; each of the second lighting devices is configured for generating light projected towards a side wall of the floating chamber, and the light at least partially penetrates out of the side wall of the floating chamber.

5. The fountain lamp according to claim 2, wherein the housing is further provided with an accommodation chamber and a second through hole in communication with the accommodation chamber, the accommodation chamber is disposed between the floating chamber and the disinfection chamber, the pumping component is disposed inside the accommodation chamber, and the second through hole is configured for allowing water to pass through.

6. The fountain lamp according to claim 3, further comprising a water outlet cover, wherein the water spray holes are uniformly distributed in a circular shape along a surface of the water outlet cover, and the water outlet cover is connected to the top of the housing and capped over the water outlet channel.

7. The fountain lamp according to claim 6, further comprising a first sealing ring, wherein the housing is provided with a first sealing groove, the first sealing ring is inserted in the first sealing groove, and the water outlet cover is pressed against the first sealing groove.

8. The fountain lamp according to claim 5, wherein the housing comprises a floating housing and a disinfection housing, the floating chamber is arranged inside the floating housing, the disinfection chamber is arranged inside the disinfection housing, the disinfection housing is connected to a lower part of the floating housing, and the accommodation chamber is formed between the disinfection housing and the floating housing, and the disinfection housing comprises an upper disinfection housing and a lower disinfection housing, the upper disinfection housing sleeves the lower disinfection housing, and the lower disinfection housing is slidable up and down relative to the upper disinfection housing in order to change a volume of the disinfection chamber.

9. (canceled)

10. The fountain lamp according to claim 7, wherein the upper disinfection housing is provided with a first stop block in a lower part of an inner surface, the lower disinfection housing is provided with a second stop block in an upper part of an outer surface, and the first stop block abuts against the second stop block.

11. The fountain lamp according to claim 10, wherein the upper disinfection housing is provided with a first slider on an inner surface thereof, the second stop block is provided with a sliding hole, and the first slider is slidably disposed inside the sliding hole so that the lower disinfection housing is slidable relative to the upper disinfection housing.

12. The fountain lamp according to claim 7, further comprising a rotating housing, wherein the rotating housing is provided with a first opening, the upper disinfection housing is provided with a second opening, and the rotating housing is rotatably sleeved in the upper disinfection housing and rotatable between an open position and a closed position rotating; when in the open position, the first opening aligns with the second opening; when in the closed position, the first opening is staggered from the second opening, and the rotating housing covers the second opening.

13. The fountain lamp according to claim 7, further comprising an adjusting housing, wherein the adjusting housing is provided with adjusting holes, and the adjusting housing rotatably nests the lower disinfection housing and is rotatable between an open position and a closed position; when in the open position, the adjusting holes align with the first through holes; when in the closed position, the adjusting holes are misaligned with the first through holes, and the adjusting housing covers the first through holes.

14. The fountain lamp according to claim 7, wherein the lower disinfection housing is provided with third through holes at a bottom of the lower disinfection housing, and the third through holes are in communication with the disinfection chamber.

15. The fountain lamp according to claim 13, wherein the lower disinfection housing is further provided with a curved rotation groove at the bottom of the lower disinfection housing, the adjusting housing is provided with a second slider, and the second slider is slidably disposed in the rotation groove.

16. The fountain lamp according to claim 15, wherein a free end of the second slider is provided with a limiting block, and the limiting block abuts against an inner wall of the lower disinfection housing.

17. The fountain lamp according to claim 8, wherein the floating housing comprises an upper floating housing and a lower floating housing, the upper floating housing is connected to and covers the lower floating housing, the lower floating housing is substantially in a bowl shape, and the floating chamber is formed between the upper floating housing and the lower floating housing.

18. The fountain lamp according to claim 17, further comprising a second sealing ring, wherein the upper floating housing is provided with a second sealing groove, the second sealing ring is arranged in the second sealing groove, the lower floating housing is inserted along the second sealing groove, and the lower floating housing abuts against the second sealing ring.

19. The fountain lamp according to claim 17, wherein the upper floating housing extends downwardly in a middle to form a connecting portion, the water outlet channel is provided in the connecting portion, the connecting portion is connected to a middle of the lower floating housing by a connecting member, and a third sealing ring is provided between the connecting portion and the lower floating housing.

20. The fountain lamp according to claim 6, further comprising a blocking member, wherein the blocking member is detachably connected to a lower surface of the water outlet cover and inserted into the water outlet channel, so that a water outlet gap communicated with the water spray holes is formed between an inner wall of the water outlet channel and an outer wall of the blocking member.

21. A fountain lamp, comprising:
a housing, wherein the housing is provided with a closed floating chamber in an upper part and a water outlet channel passing through the floating chamber, the water outlet channel is provided with water spray holes at an upper end, and the floating chamber is transparent;
a lighting component, wherein the lighting component is arranged inside the floating chamber and configured for projecting light to form a column of light;
a pumping component, wherein the pumping component is connected to the housing and at least partially provided at a lower part of the floating chamber, the pumping component is in communication with the water outlet channel, and the pumping component is used for pumping water through the water outlet channel to the water spray holes to form a column of water;
a water entry sensing device, wherein the water entry sensing device is installed inside the housing, a horizontal plane where a sensing end of the water entry sensing device is positioned is lower than a horizontal plane where a water pumping opening of the pumping component is positioned, and the water entry sensing device is configured for detecting whether a liquid surface submerges the water pumping opening of the pumping component and outputting a control signal; and
a control component, wherein the control component is electrically connected to the water entry sensing device and the pumping component, and the control component is configured for receiving the control signal and controlling the pumping component to be turned on or turned off;
a rotating housing having a first opening;
wherein the housing comprises a floating housing and a disinfection housing, the floating chamber is arranged inside the floating housing, the disinfection housing defines a disinfection chamber, the disinfection housing is connected to a lower part of the floating housing,
wherein the disinfection housing is provided with a second opening, and the rotating housing is detachably and rotatably sleeved in the disinfection housing and rotatable between an open position and a closed position rotating; when in the open position, the first opening aligns with the second opening, for facilitating putting a disinfecting substance into the disinfection chamber or taking the disinfecting substance out of the disinfection chamber; when in the closed position, the first opening is staggered from the second opening, and the rotating housing covers the second opening, such that the disinfecting substance can be prevented from leaving the disinfection chamber through the first opening and the second opening.
